(19) United States
(12) Patent Application Publication
(10) Pub. No.: US 2005/0166435 A1
(43) Pub. Date: Aug. 4, 2005

(54) Display apparatus

(76) Inventors: Scott E. Lackey, Flower Mound, TX (US); James R. Jinright, Flower Mound, TX (US); Douglas E. Wickwire, Lucas, TX (US)

Correspondence Address: John E. Vandigriff;Suite 200, 190 N. Stemmons Frwy, Lewisville, TX, 75067, US

(21) Appl. No.: 10/771,199

(22) Filed: Feb. 3, 2004

(51) Int. Cl. G09F 7/22

(52) U.S. Cl. 40/617

(57) ABSTRACT

A display apparatus is mountable on at least one of a dropped ceiling grid, a ceiling and a wall. The display apparatus is a partially enclosed structures having an open side. In one embodiment, there is at lease one hinge-fastener on a first side of the display apparatus adjacent to the open side is used for attaching said first side to a grid system member and at least one movable fastener on a second side of the display apparatus, opposite said first side, is used for releaseably attaching the second side to a grid system member. In another embodiment, the display apparatus is mounted by a rim extending around the open side of the display apparatus. A removable display unit is inserted into and removed from the display apparatus replacing information and advertisements therein.

### FIELD OF THE INVENTION

The invention relates to lighted displays, and more particularly to a display that is ceiling mounted in the panel opening of a dropped panel ceiling, or other location, and has a changeable display unit.

### BACKGROUND OF THE INVENTION

U.S. Pat. No. 4,290,218 is a replacement for a ceiling panel and uses incandescent lights. This patent represents a flat panel on the bottom of a ceiling unit. Retaining clips are used to attach the unit to the ceiling.

U.S. Pat. No. 4,528,764 is a light diffuser containing several translucent drop-in inserts. The first or innermost insert is a translucent diffuser sheet. There has to be an outer sheet to sandwich the film negative against the diffuser sheet. The various components are of conventional acrylic. The sidewall of the unit has a cutout with a reflective and translucent baffle seated inside. It is designed to direct light downward and defuse light. It includes at least one inclined side in order to gain a reflection through the cutout for a reflective means.

U.S. Pat. No. 5,274,938 has only a limited surface area because of its internal framing and limited window slots that strictly limit the amount of direct lighting on the display. The light units are mounted inside of the display.

### SUMMARY OF THE INVENTION

The invention is a back illuminated ceiling mounted display apparatus that attaches to the framework of ceiling panel opening in which it is mounted. The display apparatus attaches to the panel ceiling framework, and covers the a ceiling fluorescent light box which is generally mounted on the ceiling above the framework grid. The display apparatus may also be attached, not limited to, to walls, chairs, aircraft wire and other placed where information/advertising is desired.

The attachment mechanism on one side is a strip or hinge-fasteners that attaches one side of the display apparatus to the ceiling grid frame. The opposite side of the display apparatus is one or more moveable clips that secure the display apparatus frame to the grid frame. grid system, and or framework of the suspended ceiling.

A foldable removable display unit is inserted into the display apparatus to provide information or advertisements.

### BRIEF DESCRIPTION OF THE DRAWINGS

FIG. 1 shows a dropped panel ceiling with a ceiling mounted display apparatus of the present invention mounted in the one panel space;

FIG. 2 shows an unmounted display apparatus;

FIG. 3 shows the display apparatus as it is being mounted;

FIG. 4 shows one of two latches for securing the display apparatus to a ceiling frame;

FIG. 5 shows an end view of a mounted display apparatus;

FIG. 6 shows a foldable graphic insert for the display apparatus:

FIG. 7 shows a partial folded view of the insert;

FIG. 8 is an end view of the insert;

FIG. 9 shows the folded advertisement insert;

FIG. 10 shows one of two end brackets;

FIG. 10a shows a cross-sectional view of the end bracket.

FIG. 11 shows a side view of an embodiment of an illuminated display apparatus;

FIG. 12 is an end view of the embodiment of FIG. 11;

FIG. 13 shows a graphic insert for use in the display apparatus FIG. 14 is an isometric view of the display holder/mount of the display apparatus of FIG. 11;

FIG. 15 is a side view of the display holder/mount of FIG. 14,

FIG. 16 shows the graphic panel parts of FIG. 13 as it is inserted into the display/holder of FIG. 14; and

FIG. 17 shows a display apparatus with the graphic panel parts, and an insert graphic “pinch” that holds the graphic panel parts in place.

### DESCRIPTION OF A PREFERRED EMBODIMENT

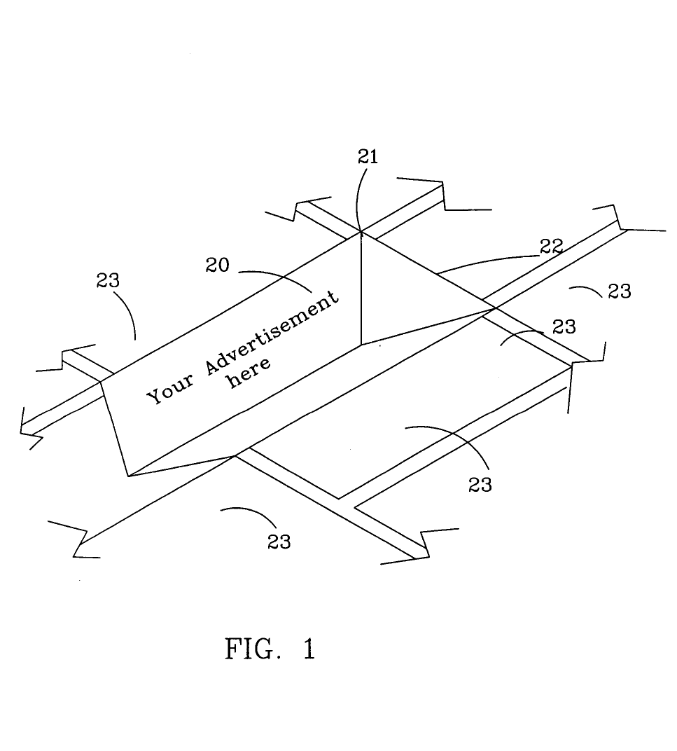

FIG. 1 shows A display apparatus 20 mounted in an opening 22 in a dropped ceiling. The dropped ceiling includes a grid frame 21, and panels 23 mounted in the grid frame. A panel 23 is removed and display apparatus is mounted in the opening.

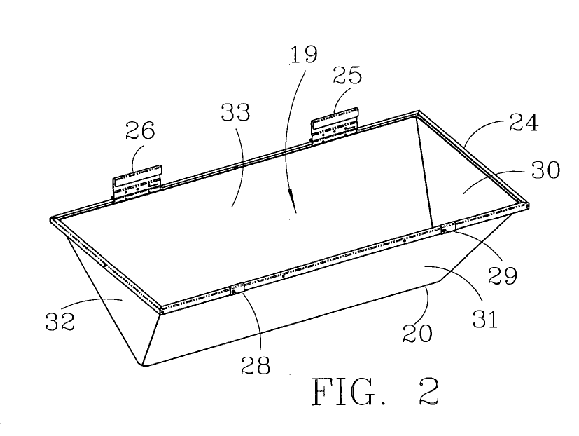

FIG. 2 is an isometric view of display apparatus 20 with a frame 24 on each side of the opening 19. There maybe be two individual hinge-fasteners 25 and 26 on one side, and at least two latches 28 and 29 on the side opposite the side on which the hinge-fasteners 25 and 26 are mounted. In another configuration, there may be one hinge-fastener that extends at least partially along the length of one side of display apparatus 20. Hinge-fasteners 25 and 26 are adjustably secured to a part of the grid frame 21 by placing a part of each hinge-fastener 25 and 26 over the frame. The opposite side is then secured to frame 21 by the latches 28 and 29. Display unit may be placed in a grid frame opening below a light to provide back illumination for display apparatus 20.

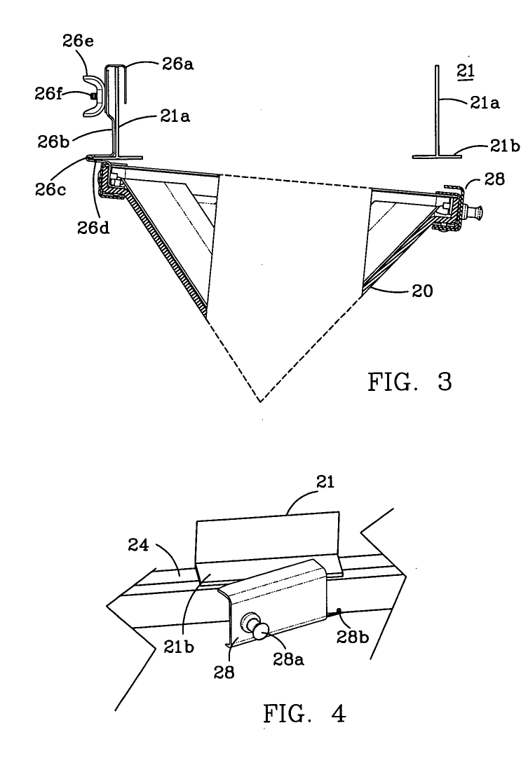

FIG. 3 shows a display apparatus as it is being mounted in frame 21. Frame 21 is made up of a grid of T-shaped members. Each of hinge-fasteners 26 and 26 are hooked over the upward part 21a of grid member 21. As illustrated, hinge-fastener part 26a is U-shaped and is placed over part 21a. Part 26 a is secured to part 26b by a screw 26f and wing nut 26e. Part 26b is attached to part 26d by hinge 26c and to the frame 24 of the display apparatus. Part 26a is slidably adjustable on part 26b before nut 26f is tightened on nut 26f. This adjustable features allows an adjustment depending upon the size (height) of the grid part 21a.

After hinge-fasteners 25 and 26 are secured to frame 21, then display apparatus 20 is pivoted upward and latches 28 and 28 are pivoted outward to allow frame 24 to be positioned against the bottom side of grid part 21b. When display apparatus is in place, the latches 28 and 29 are pivoted against framed 24, with a portion of the latch being positioned over grid part 21b, holding display apparatus in position.

FIG. 4 shows latch 28 pivoted outward to allow grid part 21b and frame 24 to come adjacent to each other. Latch 28 has a portion 28b that extends under frame 24 and is attached thereto (not illustrated) by a pin to allow latch 28 to pivot outward to allow frame 24 and grid part 21b to come together as display apparatus 20 is moved upward. The latch 28 is pivoted inward to secure frame 24 to grid part 21b.

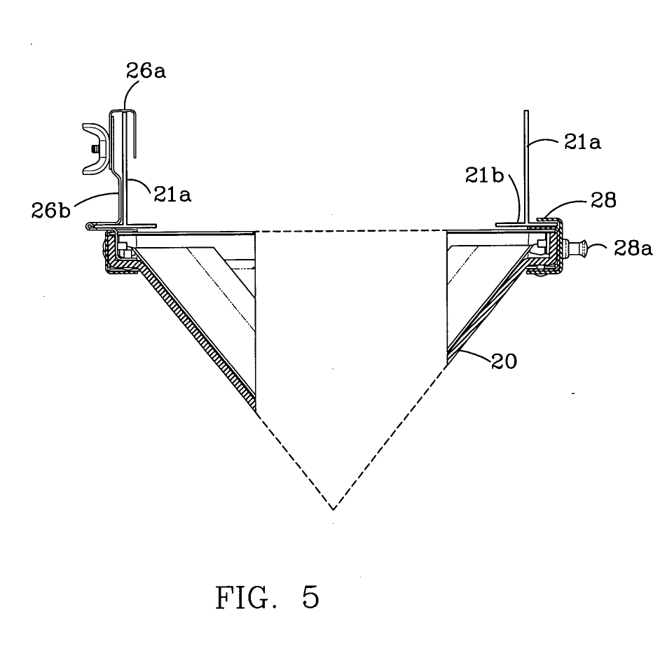

FIG. 5 is an end view showing display apparatus in a mounted position, held in place by hinge-fastener 26 (and 25) and latch 28. Latch 28 has a movable pin 28a that is used to secure latch 28 in a fastened position.

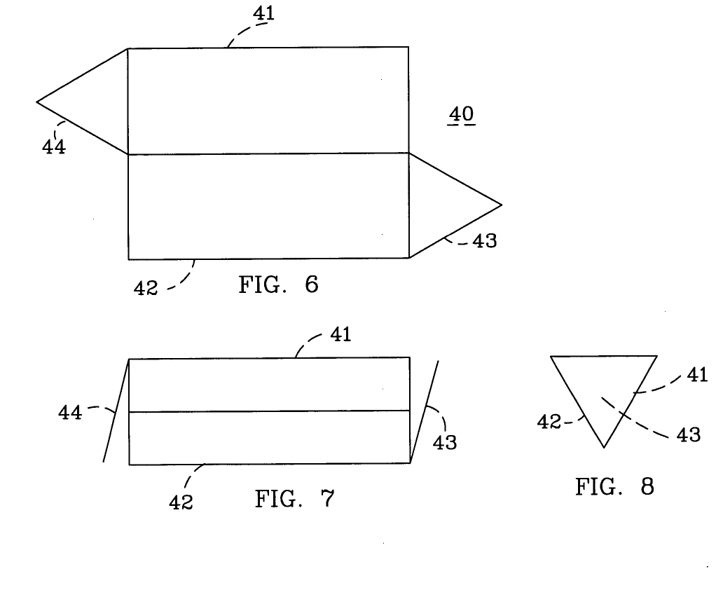

Display apparatus 20 may have four sides 30, 31,32 and 33. Each of these sides may have display information/advertisements on them. However, to render display apparatus more flexible in use, the sides may be clear or transparent and a changeable advertisement unit may be placed inside of display apparatus 20. FIG. 6 shows a flat display unit that may be folded for inserting inside of display apparatus 20. By providing a flat display unit, it is easier to print information thereon and then fold the display unit. Display unit 40 may have, for example two sides 41 and 42 and two ends 43 and 44. Printing may be placed on each of the sides and ends.

FIG. 7 shows display unit 40 in a partially folded position. Sides 41 and 42 have been folded upward to form a V-shape structure, and ends 43 and 44 are folded to enclose the open ends of sides 41 and 41 after folding. FIG. 8 shows an end view of display unit after the sides and ends have been folded.

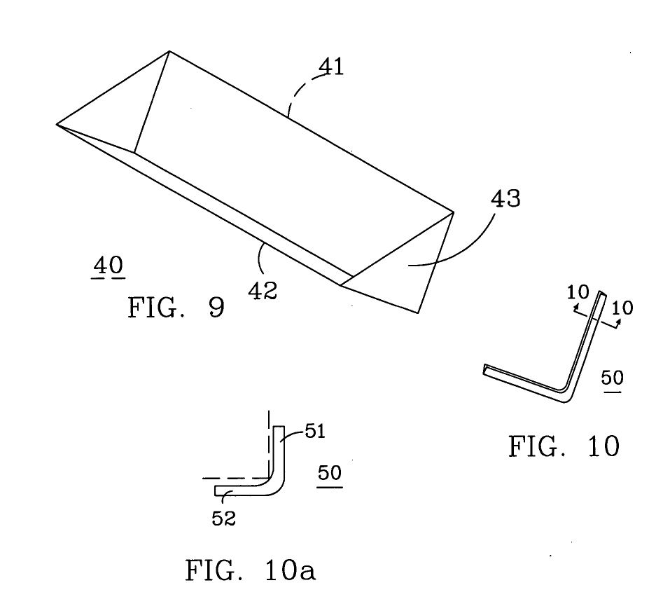

FIG. 9 is an isometric view of folded display unit 40. To hold the edges of the sides 41 and 42 and ends 43 and 44 together, a V-shaped guide/fastener (FIG. 10) is used to hold the ends together and to cover the ends when the display unit 40 is placed into display apparatus 20. A cross sectional view of guide 50 is shown in FIG. 10a, with a side and end of a display unit shown with dashed lines. By having a removable display unit 40, information displays and advertisements may be changed in display apparatus 20 by simple changing out the display unit 40.

The guide/fastener 50, or modifications thereof, shown in FIGS. 10 and 10a, may be used to hold multiple graphics such as that illustrated in FIGS. 7 and 13 to present lenticular displays. With such multiple graphics you can have a range of graphical effects can be created that are not mutually exclusive. For example, you can have a 3D piece with elements that flip, morph, zoom and/or have motion. These elements cause variation in the display such as: (1) 3D—The optical illusion of depth and distance between elements from the foreground to the background: (2) Flip—The quick transition between distinct graphical elements. In many cases, flip images can be improved with subtle incorporation of morphing; (3). Morph—A fluid transition between graphical elements, usually of like size and shape; (4) Zoom—Image moves front to back gaining or decreasing in size; and (5) Motion—The re-creation of a motion event from video or series of stills.

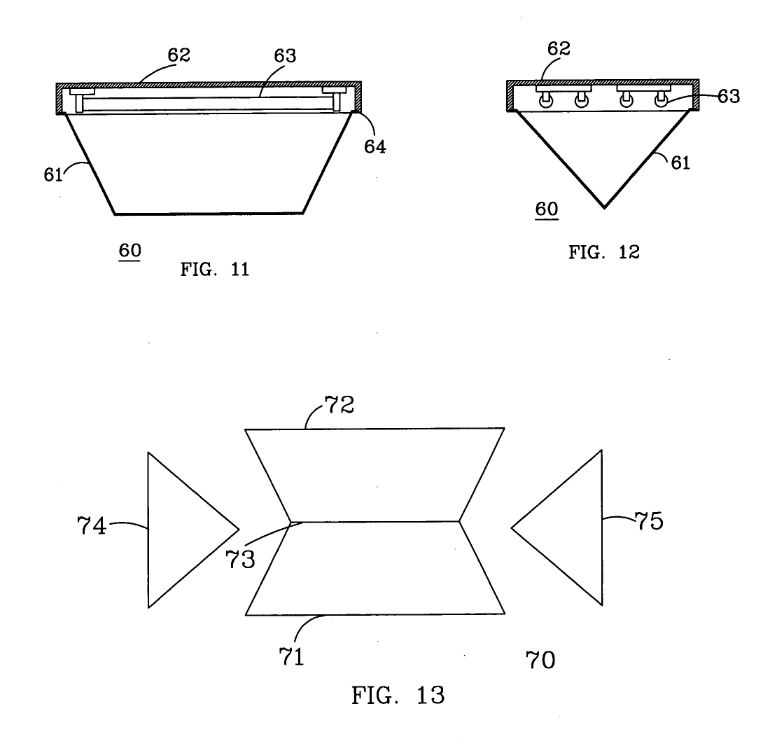

FIG. 11 is a side view of a display device 60 that may be either ceiling mounted or wall mounted. Display device 60 includes a display holder 61 that is mounted in a light box 62 utilizing a mounting rim 64. Light box 62 includes one r more lights 63. Display 60 may be mounted on the grid of a dropped ceiling as shown in FIG. 1, Mounted on a non-dropped ceiling, or mounted on a wall or other mounting device, including, but not limited to, chairs, aircraft wires and other areas where information/advertising is desired.

FIG. 12 is an end view of display device 60 showing display holder 61 and four lights 63.

FIG. 13 shows the parts of a graphic display 70 that may be inserted into display holder 61. Graphic display 70 includes side panels 71 and 72 to provide information displays for the sides of display device 60. Two end pieces 74 and 75 may be used for additional information displays at the ends of display device 60.

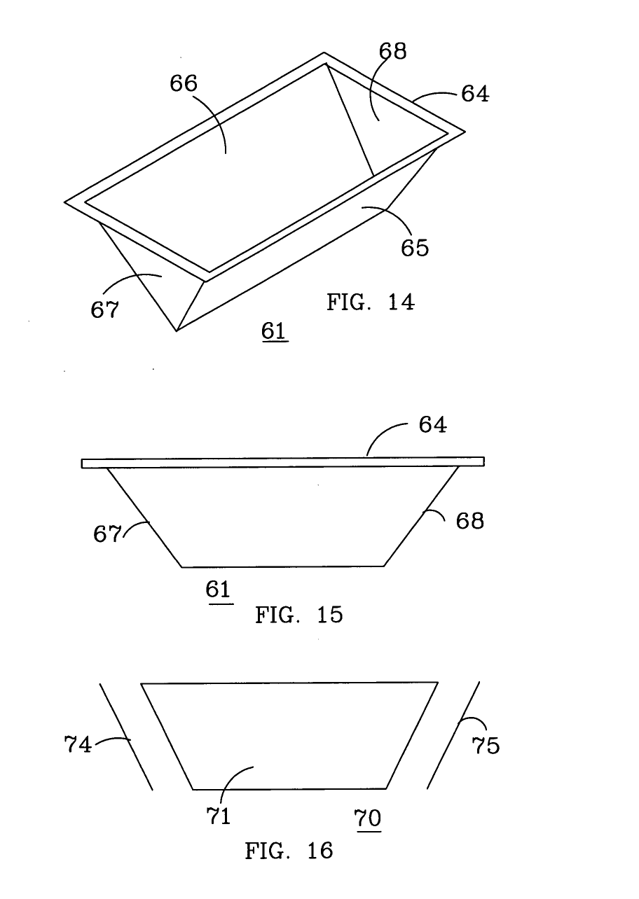

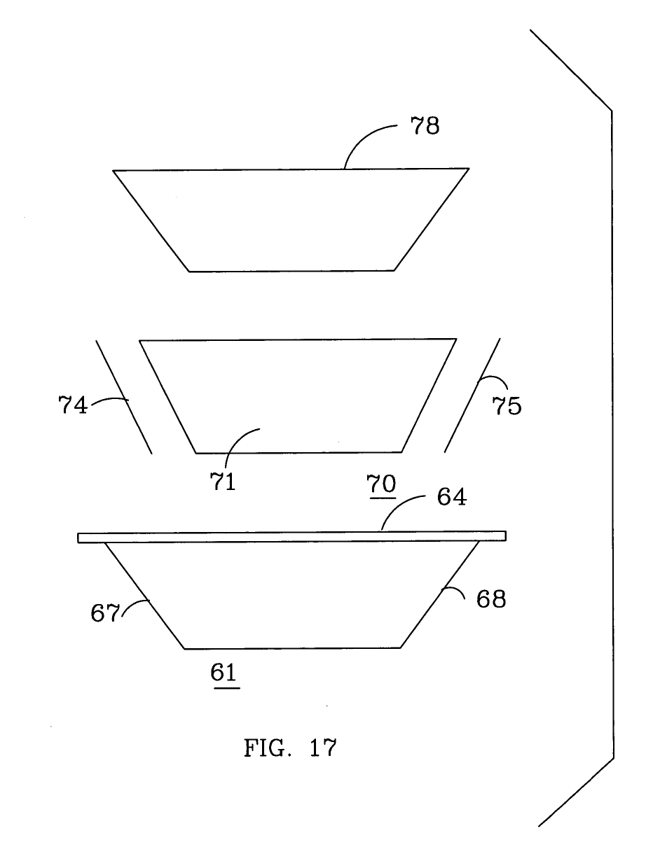

FIG. 14 is an isometric view of the display holder 61 and FIG. 15 is a side view. These two views show sides 65 and 66, and the ends 67 and 68. The graphic display 70 is inserted into display holder 71 so that graphic display holder sides 71 and 72 are mounted adjacent, respectfully, to sides 65 and 66, and graphic display ends 74 and 75 are mounted, respectfully, to ends 67 and 68 of display holder 61. By utilizing the graphic display 70, advertisements and information displays may be changed periodically as needed. If a permanent display is to be used, the information and advertisements may be applied directly to the sides 65 and 66 and ends 67 and 68 of display holder 61. FIG. 16 shows the parts of graphic display 70 as they are inserted into display holder 61.

FIG. 17 is an exploded view of the graphic display apparatus showing the display holder 61, the graphic display 70 and a “pinch” device 78 that holds the graphic display parts 70 in place. The pinch 78 has a slightly smaller dimension than the inside of display apparatus 61 after graphics 70 is inserted. Pinch 78 may be opaque or transparent and of various colors to provide a background for the graphics on graphic display 70.

1. A display apparatus for mounting in an opening in a suspended ceiling utilizing a grid system, the grid system having an array of openings for mounting panels, said display apparatus comprising:
a partially enclosed display apparatus having an open side corresponding in size to an opening in the ceiling grid system;
at least one hinge-fastener on a first side of the display apparatus adjacent to the open side for attaching said first side to a grid system member; and
at least one movable fastener on a second side of the display apparatus, opposite said first side, for releaseably attaching the second side to a grid system member.

2. The display apparatus according to claim 1, wherein said hinge-fastener includes a U-shaped portion for attaching over a grid system member, and a hinge portion which permits the display apparatus to pivot downward when the fastener on the second side is released.

3. The display apparatus according to claim 1, including a foldable display unit for inserting into the display apparatus to display information and advertisements.

4. The display apparatus according to claim 3, wherein multiple foldable display units are used to provide lenticular displays.

5. The display apparatus according to claim 1, wherein the hinge-fastener is adjustable to move the display up and down to ensure that the display is secured against the grid system member to which it is attached.

6. The display apparatus according to claim 1, wherein the movable fastener on a second side of the display apparatus, when moved to release the second side of the display apparatus from the grid system member, allows the display apparatus to move in an arc downward exposing the open side into which a display unit is inserted.

7. The display apparatus according to claim 1, including a removable display unit which is inserted into the open side of the display apparatus.

8. The removable display unit according to claim 7, wherein the display unit is foldable to conform with the inside of a display apparatus.

9. The display apparatus according to claim 7, including two V-shaped supports to hold the display unit in a folded position.

10. A display apparatus for mounting in an opening in a suspended ceiling utilizing a grid system, the grid system having an array of openings for mounting panels, said display apparatus comprising:
a partially enclosed display apparatus having an open side corresponding in size to an opening in the ceiling grid system;
at least one hinge-fastener on a first side of the display apparatus adjacent to the open side for attaching said first side to a grid system member;
at least one movable fastener on a second side of the display apparatus, opposite said first side, for releaseably attaching the second side to a grid system member; and
a removable display unit for inserting into and removing from the display apparatus replacing information and advertisements.

11. The display apparatus according to claim 10, including two V-shaped supports for holding ends of the removable display unit in the display apparatus.

12. The display apparatus according to claim 10, wherein said hinge-fastener includes a U-shaped portion for attaching over a grid system member, and a hinge portion which permits the display apparatus to pivot downward when the fastener on the second side is released.

13. The display apparatus according to claim 10, wherein said removable display units is originally a flat material and is foldable for inserting into the display apparatus to display information and advertisements.

14. The display apparatus according to claim 13, wherein said foldable display unit is folded to correspond to the inside surfaces of the display apparatus.

15. The display apparatus according to claim 10, wherein the hinge-fastener is adjustable to move the display up and down to ensure that the display is secured against the grid system member to which it is attached.

16. The display apparatus according to claim 10, wherein the movable fastener on a second side of the display apparatus, when moved to release the second side of the display apparatus from the grid system member, allows the display apparatus to move in an arc downward exposing the open side into which a display unit is inserted.

17. The removable display unit according to claim 10, wherein the display unit is foldable to conform with the inside of the display apparatus.

18. A display apparatus comprising:
a light fixture;
a partially enclosed display apparatus having an open side corresponding in size to an opening in the ceiling grid system;
a mounting rim for mounting the display apparatus in the light fixture; and
a removable display graphic for inserting into and removing from the display apparatus replacing information and advertisements.

19. The display apparatus according to claim 18, wherein multiple display graphic are inserted into the display apparatus to provide a lenticular display.

20. The display apparatus according to claim 18, wherein said light fixture is mountable on at least one of a ceiling, a dropped ceiling grid, wall, and other mounting device.
